(19) United States
(12) Patent Application Publication
(10) Pub. No.: US 2015/0225496 A1
(43) Pub. Date: Aug. 13, 2015

(54) OPTICALLY ANISOTROPIC PARTICLES AND METHOD FOR PRODUCING SAME, AND COMPLEX AND DISPLAY DEVICE USING SAME

(71) Applicant: HAYASHI TELEMPU CO., LTD., Nagoya-shi (JP)

(72) Inventor: Takeya SAKAI, Nagoya-shi (JP)

(73) Assignee: HAYASHI TELEMPU CO., LTD., Nagoya-shi (JP)

(21) Appl. No.: 14/694,078

(22) Filed: Apr. 23, 2015

Related U.S. Application Data
(63) Continuation of application No. PCT/JP2013/077555, filed on Oct. 10, 2013.

(30) Foreign Application Priority Data
Oct. 26, 2012 (JP) 2012-236477

(51) Int. Cl. C08F 122/10; G02F 1/1335; C09K 19/38; G02F 1/1334

(52) U.S. Cl. CPC C08F 122/10; G02F 1/1334; G02F 1/133528; C09K 19/3809

(57) ABSTRACT

A group of optically anisotropic particles that is used in dispersing the particles in a matrix material, the group being constituted of a plurality of particles each having an independently fixed oriented state in a liquid crystal droplet.

### CROSS-REFERENCE TO THE RELATED APPLICATION

This application is a continuation application, under 35 U.S.C. §111(a), of international application No. PCT/JP2013/077555, filed on Oct. 10, 2013, which claims priority to Japanese Patent Application No. 2012-236477 filed on Oct. 26, 2012, the entire disclosure of each of which is herein incorporated by reference as a part of this application.

### FIELD OF THE INVENTION

The present invention relates to particles having optical anisotropy, method of producing the same, a complex body and a display device utilizing the same particles. Specifically, the present invention provides particles having optical anisotropy that can be appropriately used in providing depolarization performance.

### BACKGROUND ART

A liquid crystal display device generally has a structure in which a pair of polarizing plates are disposed to the front and back surfaces of a liquid crystal cell that seals a liquid crystal composition between two transparent substrates. In the liquid crystal display device, orientation (alignment) of liquid crystals is changed by applying electric voltage to the liquid crystals through transparent electrodes attached to inner surfaces of the transparent substrates. This change of alignment is used to control transmission and shield of light from back light source device, thereby displaying an image.

Liquid crystal display devices are classified to various types depending on the alignment mode of liquid crystals, for examples, TN mode, STN mode, VA mode, IPS mode, and OCB mode. Irrespective of its alignment mode, a liquid crystal cell and a pair of polarizing plates are used in the liquid crystal display device. Therefore, in the liquid crystal display device, an observer observes linearly polarized light that has transmitted the polarizing plate disposed to the surface of the liquid crystal cell.

An organic EL display device displays an image by spontaneous light emission, where external light reflected by a metal electrode of high reflectance deteriorates the image contrast. A circularly polarizing plate having a laminated layers of a ¼ wavelength plate and a polarizing plate is used to inhibit the reflection of external light. Therefore, an observer who observes the organic EL device also observes linearly polarized light that has transmitted the polarizing plate disposed to the surface of the organic EL display device.

In recent years, digital terrestrial television broadcasting for receivers made of mobile devices such as cell-phones are becoming popular and spreading audio-visual sensing of “one segment reception service for cell phone and/or mobile terminal”. The use of liquid crystal display devices and/or organic EL devices in dashboards of automobiles and car navigation devices are also expanding. Because of such circumstances, there are increasing opportunities to use liquid crystal display devices and/or organic EL display devices in the outdoor environment or in places where the natural light has high intensity.

Polarized glasses are effectively used for resolving problems during car driving, for example, deterioration of visibility due to reflection of dashboard in the windshield and glare reflection of sun light by the rear window of preceding vehicle, and for reducing glare reflection from water surface in the time of fishing or water sports. Therefore, a viewer sometimes observes a liquid crystal display device or an organic EL device through polarized glasses. However, during the observation of liquid crystal display device (or an organic EL device) through the polarized glasses, significant deterioration of visibility occurs when the absorption axes of the polarized glasses coincident with polarization axis of the liquid crystal display device coincident, resulting in darkening of display image.

To solve the above-described problems, JP Laid-open Patent Publication No. 10-10522 proposes to dispose a depolarization unit to the side of a liquid crystal display screen, where a depolarization plate constituted of a pair of quartz crystal plates is used as the depolarization unit. JP Laid-open Patent Publication No. 10-10523 proposes to provide a birefringent plate such as a ¼ wavelength plate by which the display light emitted from the liquid crystal display screen is converted from linearly polarized light to circularly polarized light or elliptically polarized light.

It is not a practical solution to cover all area of the liquid crystal display screen by a depolarization unit of Patent Reference 1 constituted of a pair of quartz crystal plates. According to the method of JP Laid-open Patent Publication No. 10-10523, even though darkening does not occur by the use of polarized glasses, problematic large shift of color tone of an image occurs by the tilts of viewer's head in bilateral direction.

In the field of cell phone and mobile terminal, further decrease of thickness and simplification of the structure are required. Provision of quartz crystal plates or a birefringent plate such as a ¼ wavelength plate, as required by JP Laid-open Patent Publication No. 10-10522 and JP Laid-open Patent Publication No. 10-10523, causes complication and thickening of the structure.

To solve the above-described problems, the inventor proposed a process utilizing a simple constitution by which darkening of image and deterioration of visibility are suppressed during observation of a display device such as a liquid crystal display device or an organic EL device through head-mounted polarized glasses.

In International Publication No. WO2010/101140, the inventor proposed a method for dispersing optically anisotropic volume regions in optically isotropic hard coat layer and adhesive layer. For example, the inventor proposed a process including: atomizing a material that exhibits optical anisotropy by irradiation of polarized light; dispersing atomized particles; and irradiating polarized light to the particles, and a process including dispersing powder of optically anisotropic crystalline material.

### SUMMARY OF THE INVENTION

It is not a practical solution to cover all area of the liquid crystal display screen by a depolarization unit of JP Laid-open Patent Publication No. 10-10522 constituted of a pair of quartz crystal plates. According to the method of JP Laid-open Patent Publication No. 10-10523, even though darkening does not occur by the use of polarized glasses, problematic large shift of color tone occurs by the tilts of viewer's head in bilateral direction.

In the field of cell phone and mobile terminal, further decrease of thickness and simplification of structure are required. Provision of quartz crystal plates or a birefringent plate such as a ¼ wavelength plate, as required by JP Laid-open Patent Publication No. 10-10522 and JP Laid-open Patent Publication No. 10-10523, causes complication and thickening of the structure.

According to the method of International Publication No. WO2010/101140, darkening of image and deterioration of visibility are suppressed by a simple constitution when a viewer observes the display using head-mounted polarized glasses of simple constitution. However, since the process of Patent Reference 3 provides optical anisotropy to the particles dispersed in the hard coat agent by irradiation of polarized light and heating followed by slow cooling, it is impossible to induce independently different orientation in each of the particles.

In such a case, there is a possibility that anisotropy in a similar direction occurs in a group of particles, resulting in alignment of the directions of optical anisotropy, thereby causing spotted inhomogeneity of depolarization performance. For example, there are occasions in that desired property cannot not be obtained sufficiently, since the depolarization performance cannot be obtained where the particles are aligned to a direction vertical or parallel to the absorption axis (or transmission axis) of the polarizing plate.

An object of the present invention is to provide particles (a group of particles) each having independent optical anisotropy, thereby exhibiting excellent depolarization performance.

Another object of the present invention is to provide optically anisotropic particles (a group of optically anisotropic particles) that can be embedded in various types of matrix materials.

Still other object of the present invention is to provide a complex body (composite) and a display device that can exhibit excellent depolarization performance.

Other object of the present invention is to provide a production method by which the above-described optically anisotropic particles can be produced efficiently.

As a result of extensive research for solving the above-described problems, the inventor found the followings.

Where a polymerizable liquid crystalline compound is dispersed in forms of droplets in a disperse medium at a temperature of not lower than the liquid crystal transition temperature, and is subsequently polymerized at a temperature below the isotropic transition temperature of the polymerizable liquid crystalline compound, liquid crystalline state of those droplets are fixed by polymerization, and particles each having optical anisotropy are formed in the disperse medium.

In the group of particles obtained by separating the particles from the disperse medium, orientated state in the liquid crystal droplet is fixed in each of the particles independently. Therefore, a complex body formed by the combination of these particles and a matrix material can exhibit excellent depolarization performance by the effect of independently fixed orientation in liquid crystal droplets. The present invention was invented based on the above-described findings.

An optical material according to the present invention is a group of particles having optical anisotropy that is used in dispersing the particles in a matrix material, the group of particles comprising a plurality of particles each having an orientated state of liquid crystal droplet fixed independently (independent of the orientation in other particles). For example, the group of particles may have an average particle diameter (average particle size) of 50 μm or lower. Each of the particles may have a quasi-spherical shape (substantially spherical shape) or quasi-spheroidal shape (substantially spheroidal shape). Preferably, the group of particles, in other words, each of the particles constituting the group is substantially immiscible with the matrix material.

An optical material according to the present invention may be a complex body including a light transmitting (e.g., transparent) matrix material and the above-described group of optically anisotropic particles. In the complex body, each of the particles having optical anisotropy may be dispersed in the matrix material with the orientations in liquid crystal droplets oriented independently from each other. The matrix material may be selected from film-forming materials, hard coat agents, adhesive agents (adhesives) or the like.

The present invention also encompasses a display device having: a polarizing plate disposed on the light emitting side of a display, and the above-described complex body disposed on a viewer's side of the polarizing plate.

The present invention also encompasses a method for producing optically anisotropic particles, the method including:

preparing a polymerizable liquid crystalline compound;

dispersing the polymerizable liquid crystalline compound in a disperse medium at a temperature of not lower than a liquid crystal transition temperature of the compound, and thereby forming liquid crystal droplets; and

polymerizing each of the liquid crystal droplets at a temperature below the isotropic transition temperature of the polymerizable liquid crystalline compound under the presence of a polymerization initiator.

In the dispersing process of the above-described production method, the disperse medium may contain water and a surfactant. Preferably, the polymerizable liquid crystalline compound is dispersed in the disperse medium in a state of emulsion.

The present invention also encompasses any combination of at least two constituent elements disclosed in claims and/or description and/or drawings. For examples, the present invention encompasses any combination of two or more elements described in claims.

Where a complex body is formed by dispersing the optically anisotropic particles according to the present invention in the matrix material composed of film forming material, hard coat agent, and adhesive agent or the like, each of the particles is embedded in the matrix material with different orientation of liquid crystals that is independent from those of other particles. Therefore, the complex body can exhibit a depolarization function while suppressing reduction of brightness of the light transmitting the complex body. Specifically, since the molecular orientation of liquid crystals in each particle (droplet) is independent from that of other particles (droplets), it is possible to suppress occurrence of spot-like regions that cannot exhibit depolarization function even when a group of particles are aligned in a constant direction.

In addition, since the orientation (of liquid crystals) in each of the optically anisotropic particles are fixed before combining the particles with the matrix material to form the complex body, it is possible to use the particles in various types of matrix materials while ignoring miscibility with the matrix materials.

In addition, where the complex body is disposed to the viewer's side of the display device such as a liquid crystal display device and an organic EL display device, it is possible to inhibit deterioration of visibility as a result of darkening of a display even when head-mounted polarized glasses are used for observation.

In the present invention, since the polymerizable liquid crystalline compound dispersed in the disperse medium is polymerized while maintaining optically oriented state, it is possible to produce a group of these particles simply and efficiently.

### BRIEF DESCRIPTION OF DRAWINGS

The present invention will be understood clearly based on the below described explanation of preferred embodiments with reference to the attached drawings. However, it should be noted that the embodiments and drawings are merely illustrative and explanatory examples, and are not limiting the scope of the invention. The scope of the invention is determined by the attached claims. In the attached drawings, same elements in different drawings are shown by the same symbols.

FIG. 1 is a schematic drawing that illustrates an embodiment of a complex body according to the present invention.

FIG. 2 is a schematic drawing that illustrates an embodiment of a complex body according to the present invention.

FIG. 3 is a schematic drawing that illustrates an embodiment of a complex body according to the present invention.

FIG. 4 is a schematic drawing that illustrates an embodiment of a complex body according to the present invention.

### DESCRIPTION OF EMBODIMENTS

Basic Constitution of Complex Body

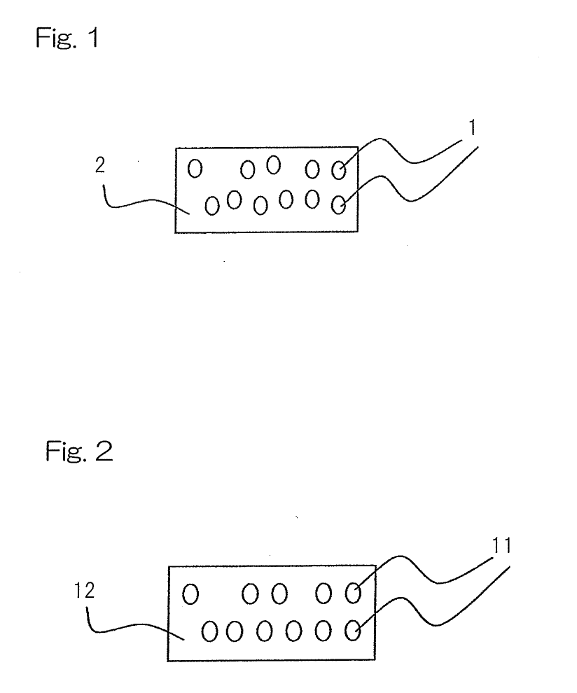

FIG. 1 shows a schematic drawing of a complex body according to an embodiment of the present invention. In the complex body shown in FIG. 1, optically anisotropic particles 1 according to the present invention are dispersed in a light transmitting (transparent) matrix material 2. The particles (group of particles) 1 are constituted of a plurality of particles each of which is made of liquid crystal droplet in which liquid crystal phase is oriented independently from other particles. Orientation of liquid crystals is fixed in each of the particles 1 independently from other particles 1. Therefore, in the group of particles 1, orientations of liquid crystals are generally different in different particles 1.

It is possible to provide depolarization function by the presence of optically anisotropic particles 1 embedded in the matrix material 2, wherein the group of particles 1 dispersed in the matrix is constituted of a plurality of particles 1 each having an independent orientation in the liquid crystal droplet.

Light Transmitting Matrix Material

In the present invention, the matrix material that disperses optically anisotropic particles therein has light-transmitting (e.g., transparent) property and fixes the optically anisotropic particles while maintaining substantially uniform distribution of the particles. Known or common material such as thermoplastic resins, thermosetting resins, photo-curing resins, and moisture-curing resins may be used as the matrix material depending on the purpose. It is possible to utilize various types of resins since the optically anisotropic particles of the present invention exhibit anisotropy at solid state, and therefore, escape from problems such as bleeding.

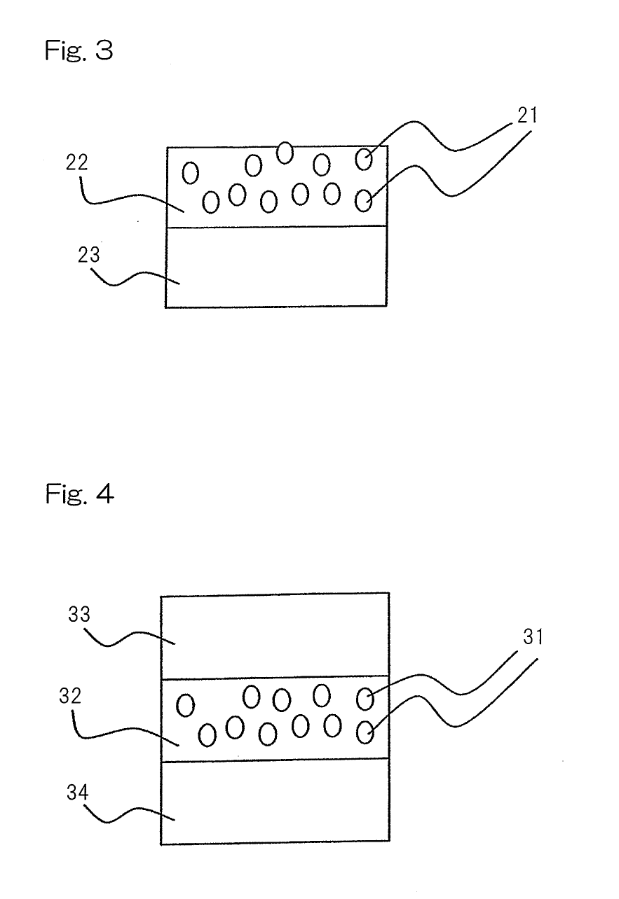

For example, the light-transmitting matrix material may be selected from a film forming material (material that constitutes a film) exemplary shown in the schematic drawing of FIG. 2, a hard coat layer formed on the surface of the film, as exemplary shown in the schematic drawing of FIG. 3, or an adhesive layer as exemplary shown in the schematic drawing of FIG. 4. In FIG. 2, FIG. 3, and FIG. 4, 12 denotes a film forming material, 22 denotes a hard coat agent, 32 denotes an adhesive agent. 11, 21, and 31 denote optically anisotropic particles, 23 denotes a substrate film, 33 and 34 denote adherends respectively.

Formation of Complex Body

Oriented state of liquid crystal phases in each of the optically anisotropic particles of the present invention is fixed independently from each other (particles) in the light-transmitting matrix material. By the presence of such structure, the complex body can exhibit excellent depolarization performance. Preferably, the optically anisotropic particles are dispersed (distributed) substantially homogeneously in the complex body. The substantially homogeneous distribution can be achieved by mixing and stirring the matrix material and the particles using known and/or commonly used method.

Where the matrix material is a material that constitutes a film (film forming material), the optically anisotropic particles are added to molten matrix material or a solution of the matrix material to form a dispersion, and the dispersion is stirred to obtain a complex material including the optically anisotropic particles. The matrix material and the optically anisotropic particles may be mixed in one time. Alternatively, the complex material may be formed by a process including: firstly preparing a raw mixture (masterbatch) including the optically anisotropic particles and partial amount of the matrix material; and subsequently adding the balance amount of the matrix material to the raw mixture. A film may be formed from the complex material through known and/or commonly used method, for example, by extrusion molding of the complex material, or by film formation by coating. Thus, a complex body having a film including optically anisotropic particles dispersed and fixed therein may be obtained.

Even when the optically anisotropic particles have substantially spheroidal shapes and are morphologically aligned to a constant direction, for example as shown in FIG. 2, during the film formation process, the film can exhibit depolarization function since each of the particles includes oriented internal structure independently.

Where the matrix material is a hard coat agent, a hard coat layer including optically anisotropic particles is formed by coating a dispersion including a solution of the hard coat agent and the optically anisotropic particles dispersed in the solution on a substrate. Depending on the type of the hard coat material, the hard coat agent layer is hardened by irradiation of electromagnetic wave such as ultraviolet ray or electron beam, by heating, by adding moisture content, or by combination thereof. As a result, fluidity of the agent is lost or reduced, and a complex body including optically anisotropic particles dispersed and fixed therein is formed.

Where the matrix material is an adhesive agent, a complex material including optically anisotropic particles is obtained by a process including: adding optically anisotropic particles to a hardenable (curable) adhesive agent; and stirring the agent added with the particles. Like as the above-described case of using film forming material, mixing may be performed in one step process, or may be performed by firstly forming a raw mixture, and forming a desired complex material using the raw mixture. An adhesive layer may be formed by injecting the complex material into the interstices between the adherends (bodies to be adhered) facing each other, or by coating the complex material on a surface of a first adherend, and subsequently pressing a second adherend against the coated surface of the first adherend. Like as the hard coat agent layer, the adhesive agent layer is hardened such that the fluidity is lost or reduced, thereby forming a complex body dispersing and fixing the optically anisotropic particles therein.

Optically Anisotropic Particles

Optically anisotropic particles according to the present invention constitute a group of particles having optical anisotropy that are used to be dispersed in the matrix material. The group of particles is constituted of a plurality of particles each having an oriented state in the liquid crystal droplet (orientation of liquid crystals within the droplet) fixed independently.

Optically anisotropic particles constituting the group of optically anisotropic particles can be produced by a method at least including:

preparing a polymerizable liquid crystalline compound;

mixing the polymerizable liquid crystyalline compound and polymerization initiator to form a mixture;

adding the mixture in a disperse medium and stirring the disperse medium added with the mixture at a temperature of not lower than the liquid crystal transition temperature of the compound to disperse the compound in the disperse medium, and thereby forming liquid crystal droplets; and

polymerizing the liquid crystal droplets under the presence of the polymerization initiator at a temperature below isotropic transition temperature of the compound.

Preferably average particle diameter of the optically anisotropic particles is smaller than a pixel size of a display. The average particle diameter of the optically anisotropic particles may be controlled depending on the pixel size, for example, to be 50 μm or less, preferably 30 μm or less. In many case, the average particle diameter is 0.5 μm or more. The average particle diameter may be determined by micropore electrical resistance method (electrical sensing zone method) using a particle size distribution analyzer (for example, Multisizer manufactured by Beckman Coulter, Inc.).

Preparation of Polymerizable Liquid Crystalline Compound

The polymerizable liquid crystalline compound is not limited as long as the compound has a unit constituted of a group that forms mesogen and can form a liquid crystal droplet. Therefore, various polymerizable liquid crystalline compounds may be used. For example, the polymerizable liquid crystalline compound may be a liquid crystalline compound or a mixture of liquid crystalline compounds each showing nematic, cholesteric, or smectic liquid crystal phase and having a unit (molecular framework) selected from schiff-based unit, biphenyl-based unit, terphenyl-based unit, ester-based unit, thioester-based unit, stilbene-based unit, tolans unit, azoxy-based unit, azo-based unit, phenyl cyclohexane-based unit, pyrimidine-based unit, cyclohexyl cyclohexane-based unit, trimesic acid-based unit, triphenylene-based unit, turxene-based unit, phthalocyanine-based unit, or porphyrin-based unit.

The above-described unit constituted of mesogen-forming group may exist in the main chain or in the side chain of the liquid crystal polymer. The main chain type liquid crystal polymer may be a liquid crystal polymer (LCP) or a mixture of liquid crystal polymers (LCPs) each selected from polyester based LCPs, polyamide based LCPs, polycarbonate based LCPs, polyimide based LCPs, polyurethane based LCPs, polybenzimidazole-based LCPs, polybenzoxazole-based LCPs, polybenzothiazole LCPs, polyazomethine-based LCPs, polyesteramide-based LCPs, polyestercarbonate-based LCPs, polyesterimide-based LCPs, or the like. The side-chain type polymer may be a liquid crystal polymer or a mixture of liquid crystal polymers (LCPs) each selected from polyacrylate-based LCPs, polymethacrylate-based LCPs, polysiloxane based LCPs, polyether based LCPs, polymalonate based LCPs, or the like, wherein mesogen groups are bonded as side chains to the linier chain framework of cyclic framework of the polymer.

Optionally, crosslinking (cross-linkable) groups may be introduced to the polymerizable liquid crystalline compound, or the polymerizable liquid crystalline compound may be blended with a crosslinking agent such that orientation of the liquid crystal polymer may be fixed under the liquid crystal state or at a state being cooled under the liquid crystal transition temperature by crosslinking (thermal crosslinking or photo crosslinking) or the like. Liquid crystal polymer of this type is not particularly limited provided that the polymer shows nematic, cholesteric, or smectic liquid crystal phase, and has a unit constituted of mesogen forming group.

The crosslinking group may be selected from vinyl group, vinyloxy group, 1-chlolovinyl group, isopropenyl group, 4-vinylphenyl group, acryloyloxy group, methacryloyloxy group, oxiranyl group, oxetanyl group, or the like, where acryloyloxy group, methacryloyloxy group, vinyloxy group, oxiranyl group, or oxetanyl group are preferred, and acryloyloxy group is specifically preferred.

Formation of Dispersion including Liquid Crystal Droplets

In the process of dispersing liquid crystal droplets, the liquid crystal droplets in the dispersed state is formed by stirring the polymerizable liquid crystalline compound in the disperse medium at a temperature of not lower than the liquid crystal transition temperature. Various solvent may be used as the disperse medium provided that the solvent may hold the dispersive state of the polymerizable liquid crystalline compound. For example, water, alcohols, ethers, ketones, esters, or the like may be used as the disperse medium.

The disperse medium is not particularly limited provided that the agent can be used to disperse the polymerizable liquid crystalline compound therein. Preferably, the disperse medium includes a solvent and a surfactant so as to disperse the polymerizable liquid crystalline compound satisfactorily. The solvent may be selected form solvents, for example, water, alcohols, or the like, that are immiscible with the polymerizable liquid crystalline compound. The surfactant may be selected from anionic surfactants such as a fatty acid sodium, a monoalkyl sulfate, an alkyl polyoxyethylene sulfate, an alkylbenzene sulfonate, and a monoalkyl phosphate; cationic surfactants such as an alkyl trimethyl ammonium salt and a dialkyl dimethyl ammonium salt; an amphotenic surfacrants such as an alkyl dimethyl amine oxide, an alkyl carboxy betaine; and non-ionic surfactants such as an polyoxyethylene alkyl ether, a sorbitan fatty acid ester, an alkyl polyglucoside, a polyethylene glycol, and a polyvinyl alcohol.

Preferably, so as to form polymerizable liquid crystalline compound particles having small diameters, the polymerizable liquid crystalline compound may be dispersed in the disperse medium in a state of emulsion in the dispersing process.

Polymerization Process

In the polymerization process, the liquid crystal droplets are polymerized under the presence of polymerization initiator at a temperature below the isotropic transition temperature polymerizable liquid crystalline compound. The isotropic transition temperature denotes a temperature at which liquid crystal phase is transformed to isotropic phase during heating. The temperature below the isotropic transition temperature includes the temperature below the liquid crystal transition temperature that is lower than the isotropic transition temperature. The polymerization initiator may be appropriately selected from either a photo-polymerization initiator or a thermal polymerization initiator depending on the types of the polymerizable liquid crystalline compound.

The photo-polymerization initiator may be selected from commercially available photo-polymerization initiators such as Irgacure 907, Irgacure 184, Irgacure 651, Irgacure 819, Irgacure 250, and Irgacure 369 available from Ciba Japan K.K.; SEIKUOL BZ, SEIKUOL Z, and SEIKUOL BEE available from Seiko Chemical Co., Ltd.; Kayacure BP100 available from NIPPON KAYAKU Co., Ltd.; Kayacure UV1-6992 available from The Dow Chemical Company; ADEKA OPTOMER SP-152 and ADEKA OPTOMER SP-170 available from ADEKA CORPORATION; TAZ-A and TAZ-PP available from Nippon Siebel Hegner Ltd.; and TAZ-104 available from SANWA CHEMICAL CO., LTD.

The thermal polymerization initiator may be selected from azo-compounds such as azo-bis(isobutyronitrile); peroxides such as hydrogen peroxide, surfer peroxide, and benzoyl peroxide.

Preferably, content of the polymerization initiator may be 0.1 to 30 parts by mass, more preferably 0.5 to 10 parts by mass, more preferably 0.5 to 8 parts by mass relative to 100 parts by mass of the polymerizable liquid crystalline compound. Where the content of the polymerization initiator is within the above-described range, it is possible to polymerize the polymerizable liquid crystalline compound without disturbing its orientation.

Where the photo-polymerization initiator is used as the polymerization initiator, it is possible to use photosensitizer in combination. For example, the photosensitizer may be selected from xanthone and xanthone compounds such as thioxanthones (for example, 2,4-diethylthioxanthone, 2-isopropylthioxanthone), anthracene and anthracene compounds such as alkoxy-group containing anthracenes (for example, dibuthoxy anthracene or the like), phenothiazine, rubrene or the like.

Optically anisotropic particles may be obtained by polymerizing the liquid crystal droplets each having liquid crystalline orientation at a temperature below the isotropic transition temperature and thereby fixing the oriented structure of the liquid crystal droplets.

In general, such optically anisotropic particles may maintain quasi-spherical or quasi-spheroidal shapes of liquid crystal droplets in the disperse medium. In addition, since the orientated structure is already fixed in each of the particles, the particles may be embedded in the matrix material without substantially dissolving in the matrix material.

By this constitution, different from the conventional low molecule liquid crystals or liquid crystal polymers that require fixation of orientation at a state dispersed in the matrix, it is possible to avoid concern for miscibility in the matrix material during controlling the particle size. Further, even when the matrix material is composed of a hard coat agent or an adhesive agent, it is possible to combine various types of materials without considering influence on hard coat property, hardenability, adhesiveness, photo-curability, thermal curability, or the like.

Where necessary, the optically anisotropic particles may be cleaned with water, and dried after the polymerization. Subsequently, the optically anisotropic particles may be dispersed in the matrix material.

Display Device

The complex body obtained by the above-described process is provided to a display device such as a liquid crystal display device or an organic EL device such that the complex body is disposed to the viewer's side of a polarizing plate that is disposed to the light-emitting side of a LCD panel or a OLED panel (hereafter, referred to as display) equipped with polarizing plates.

For example, the LCD panel may at lease comprise a liquid crystal cell, a first polarizing plate that is disposed to light-incident side of the liquid crystal cell, a second polarizing plate that is disposed to light-emission side of the liquid crystal cell. The complex body may be disposed to the light emission side of the second polarizing plate.

For example, the OLED panel may at least comprise an organic EL element, and a circularly polarizing plate that is disposed to the light-emission side of the organic EL element. The complex body may be disposed to the light emission side of the circularly polarizing plate that is disposed to the light emission side of the panel.

For example, as explained above, the complex body may be used as a stacking film that is stacked (layered) on the polarizing film, a hard coat layer that is coated on a substrate film, or the like. Where the optically anisotropic particles partially protrude from the outer surface of the matrix as shown in FIG. 3, it is possible to form uneven surface of the film, thereby suppressing reflection of external light.

Where the complex body is an adhesive agent layer, the complex body may be utilized by filling the adhesive agent layer, for example, to a space between the front surface of the display and the back surface of a protective glass, to a space between the front surface of the display and the back surface of a touch panel, or to a space between the front surface of the display and the back surface of a design glass, and subsequently curing (hardening) the adhesive agent layer.

The display device having the above-explained complex body may resolve the problem of remarkable deterioration of visibility even when the polarization axis of the light from the display device coincident with the absorption axis of the polarized glasses used by the viewer. When the viewer uses the polarized glasses, in addition to inhibiting darkening of the display image, it is possible to suppress large shift of color tone by the tilts of viewer's head in bilateral direction.

### EXAMPLES

The present invention will be explained in more detail based on the examples. However, it should be noted that the present invention is not limited to the below described examples as long as it does not depart from the spirit of the invention.

### Example 1

Acrylic polymerizable liquid crystalline compound (PALIOCOLOR LC-242 of BASF SE, liquid crystal transition temperature: 65° C., isotropic transition temperature: 118° C.) was prepared as polymer 1. Polymer 1 was mixed with a polymerization initiator (Irgacure 907 provided by Ciba Specialty Chemicals), where the amount of the polymerization initiator was 5 parts by weight relative to 100 parts by weigh of polymer 1. The mixture was added to aqueous solution of 10 wt. % polyvinyl alcohol to form a dispersion mixture. The dispersion mixture heated at 80° C. and was stirred sufficiently. It was confirmed that the dispersion mixture achieved an emulsion state after the stirring. The light from high pressure mercury light. (3 W/cm²) was irradiated to the emulsion for 10 minutes at a temperature of 60 to 70° C. while stirring the emulsion so as to polymerize and fix the polymer 1 in the state of liquid crystal droplets. Next, the polymerized and fixed liquid crystal droplets were separated from the disperse medium. The droplets were sufficiently washed with water and dried to obtain optically anisotropic particles having an average particle diameter of 4.1 μm.

The thus obtained optically anisotropic particles were mixed and dispersed in an ultraviolet-curable hard coat agent in an amount of 10% by weight. After coating the hard coat agent on a surface of TAC (tri acetyl cellulose) film in an amount of 10 g/m², light from an ultraviolet-radiation apparatus having a light source of high pressure mercury light was irradiated to the coating for 100 seconds. The hard coat agent lost its fluidity as a result of curing caused by the UV irradiation.

The thus prepared coated TAC film was bonded to a front surface of an LCD device. In the observation of an image from a polarizing plate of the LCD device, the image was recognized without showing darkening of display image even when the transmission axis of the polarizing plate was rotated. In addition, the coated TAC film had uneven surface, and showed improved property with respect to reflection of external light.

### Example 2

An adhesive dispersion was obtained by mixing optically anisotropic particles obtained in the same manner as in Example 1 in an acrylic adhesive agent (solvent: mixture of ethyl acetate and toluene, solid content: 20 wt. %) in an amount of 2% by weight, and stirring the agent mixed with the particles. An adhesive agent layer of 25 μm in thickness was formed on a surface of a TAC film by coating the adhesive dispersion on the surface of the TAC film, and drying solution.

The thus obtained coated TAC film was bonded to a front surface of a liquid crystal display device such that the adhesive agent layer was disposed between the front surface of the display device and the TAC film. In the observation of an image from a polarizing plate of the liquid crystal display device, the image was recognized without showing darkening of display image even when the transmission axis of the polarizing plate was rotated.

### Example 3

A complex material containing optically anisotropic particles (light-transmitting filling material) was obtained by mixing optically anisotropic particles obtained in the same manner as in Example 1 in an ultraviolet curable adhesive agent in an amount of 5% by weight and stirring the agent mixed with the particles. Using a spacer of 80 μm, the filling material was filled in the interstitial space between a pair of glasses opposed to each other, and was irradiated with a light from an ultraviolet-irradiation apparatus having a light source of high pressure mercury light for 100 seconds.

The light-transmitting filling material lost its fluidity by curing caused by the irradiation, and was adhered to the pair of glasses opposed to each other without forming air interface. Under the observation of cross nicol image using a polarizing microscope, it was confirmed that liquid crystal droplets of the liquid crystalline material were substantially uniformly dispersed in the all area of the light-transmitting filler material while forming particles each having optical anisotropy. When an image from a polarizing plate of a liquid crystal display device was observed through the above-described test sample disposed in front of the liquid crystal display device, the image was recognized without showing darkening of display image even when the transmission axis of the polarizing plate was rotated.

### Example 4

A light-transmitting filling material was obtained by mixing optically anisotropic particles obtained in the same manner as in Example 1 in a two component curing agent in an amount of 5% by weight and stirring the agent. Using a spacer of 80 μm, the filling material was filled in the interstitial space between a pair of glasses opposed to each other. The sample was held in a thermostat chamber for 60 minutes.

The light-transmitting filling material lost its fluidity by curing caused by heat, and was adhered to the pair of glasses opposed to each other without forming air interface. Under the observation of cross nicol image using a polarizing microscope, it was confirmed that the liquid crystal droplets of the liquid crystalline material were substantially uniformly dispersed in the all area of the light-transmitting filling material while forming particles each having optical anisotropy. When an image from a polarizing light from a polarizing plate of an de liquid crystal display device was observed through the above-described test sample disposed in front of the liquid crystal display device, the image was recognized without showing darkening of display image even when the transmission axis of the polarizing plate was rotated.

### INDUSTRIAL APPLICABILITY

The complex body including optically anisotropic particles of the invention dispersed in a hard coat agent, adhesive agent, or film forming material may provide depolarization performance. According to a display device equipped with the above-described complex body, it is possible to prevent reduction of visibility when the display image is observed using head-mounted polarized glasses.

While preferred embodiments according to the present invention are explained above with reference to drawings, the present various additions, modifications, and omissions can be made without departing from the scope of the present invention, and those modified constitutions are encompassed by the present invention.

What is claimed is:

1. A group of optically anisotropic particles that is used in dispersing the particles in a matrix material, the group being constituted of a plurality of particles each having an independently fixed oriented state in a liquid crystal droplet.

2. The group of optically anisotropic particles according to claim 1, wherein the particles have quasi-spherical or quasi-spheroidal shapes and an average particle diameter of the particles is 50 μm or lower.

3. The group of optically anisotropic particles according to claim 1, wherein the particles constituting the group are substantially immiscible with the matrix material.

4. A complex body comprising a light transmitting matrix material and the group of optically anisotropic particles according to claim 1, wherein the optically anisotropic particles are dispersed in the matrix material such that each particle has independently orientated structure reflecting the oriented state in the liquid crystal droplet.

5. The complex body according to claim 4, wherein the matrix material is selected from a film forming material, a hard coat agent, or an adhesive agent.

6. A display device having a polarizing plate in light emission side of the device, comprising the complex body according to claim 4 that is disposed to a viewer's side of the polarizing plate.

7. A method for producing optically anisotropic particles, comprising:
preparing a polymerizable liquid crystalline compound;
dispersing the polymerizable liquid crystalline compound in a disperse medium at a temperature of not lower than a liquid crystal transition temperature of the compound, thereby forming liquid crystal droplets; and
polymerizing the liquid crystal droplets at a temperature below an isotropic transition temperature of the polymerizable liquid crystalline compound under a presence of polymerization initiator.

8. The method according to claim 7, wherein the disperse medium contains water and a surfactant.

9. The method according to claim 7, wherein the polymerizable liquid crystalline compound is dispersed in a state of emulsion.
